(19) United States
(12) Patent Application Publication
(10) Pub. No.: US 2015/0241873 A1
(43) Pub. Date: Aug. 27, 2015

(54) MONITORING A FIRST SYSTEM OF A TECHNICAL PLANT FOR PRODUCING A PRODUCT

(71) Applicant: SIEMENS AKTIENGESELLSCHAFT, Munich (DE)

(72) Inventors: Norbert Goldenberg, Aschau i. Zillertal (AT); Martin Lehofer, Plainsboro, NJ (US); Martin Roessiger, Erlangen (DE); Otto Schmid, Roettenbach (DE); Guenther Winter, Neunkirchen/Brand (DE)

(73) Assignee: SIEMENS AKTIENGESELLSCHAFT, Munich (DE)

(21) Appl. No.: 14/423,209

(22) PCT Filed: Jun. 12, 2013
(86) PCT No.: PCT/EP2013/062107

§ 371 Date: Feb. 23, 2015

(30) Foreign Application Priority Data
Aug. 22, 2012 (EP) 12 181 365.3

(51) Int. Cl. G05B 19/418

(52) U.S. Cl. CPC G05B 19/41865; G05B 2219/31001; G05B 2219/31455

(57) ABSTRACT

Monitoring a first system of a technical plant for producing a product is performed by feeding first input data into a first logic unit; evaluating the first input data by the first logic unit; outputting first output data by the first logic unit, the output data characterizing a first status of the first system monitored. To improve known concepts for status monitoring, the first input data includes—first sensor data provided by the first sensors located in the plant, first data calculated by a first process model, the first process model mapping a first process in the plant, or first automation data of a first function of a first automation system in the plant; first design data characterizing physical variables of the first system and/or the plant, first parameterization data variable and predefinable relating to the first system and or the plant, and operating data characterizing production of the product.

### CROSS REFERENCE TO RELATED APPLICATIONS

This application is based on and hereby claims priority to International Application No. PCT/EP2013/062107 filed on Jun. 12, 2013 and European Application No. 12181365.3 filed on Aug. 22, 2012, the contents of which are hereby incorporated by reference.

### BACKGROUND

The present invention relates to a method for monitoring a first piece of equipment of a technical facility for manufacturing a product.

Such a method is used, for example, in technical facilities having condition monitoring. The condition monitoring may be based on a wide variety of sensor data, for example, data from sensors for detecting vibration and wear, data from temperature sensors for detecting elevated operating temperature, sensor data relating to the quality of the lubricant, etc.

### SUMMARY

One possible object is to improve known concepts for condition monitoring.

This inventors propose a method of the kind initially specified via the following:
routing first input data to a first logic,
carrying out the evaluation of the first input data via the first logic,
outputting first output data, which characterize a first condition of the monitored first piece of equipment, via the first logic,
   wherein the first input data comprise
first sensor data which are provided by first sensors situated in the facility,
first data calculated by a first process model, wherein the first process model maps a first process of the facility, or
first automation data of a first function of a first automation system of the facility,
first design data which characterize physical variables of the first piece of equipment and/or the facility,
first parameterization data which are variable and predefinable data with respect to the first piece of equipment and/or the facility, and
operating data which characterize the manufacture of the product.

The first logic may, for example, be designed as a first software, wherein the first logic, the first input data, and the first output data are also referred to as a first fingerprint.

The first input data, which may comprise the first sensor data, are supplied to the first logic, wherein a wide variety of first sensors may be used. For example, the first sensors may be designed to detect vibration, an elevated operating temperature, elevated current or power consumption, reduced lubricant quality or refrigerant quality, or the like, with respect to the first piece of equipment or the facility. Instead of the first sensor data or in addition to the first sensor data, the calculated first data may be comprised by the first input data, wherein the calculated first data are based on the first process model. Finally, it is also possible that the first input values comprise the first automation data, alternatively or in addition to the first sensor data and the calculated first data. For this purpose, the facility includes the first automation system, wherein the first function of the first automation system, for example, may be designed as a controller output of the first automation system.

Solely for the sake of clarity, it should be mentioned here that the term “first piece of equipment” within the present document is not limited to original equipment in terms of OEMs (original equipment manufacturers).

In order to determine the first output data to be output, the logic further accesses first design data, for example, motor power or torque, which characterize the first piece of equipment to be monitored, and first parameterization data, wherein the first parameterization data may be available, for example, as characteristic curves, envelopes, threshold values, or hysteresis curves. The first design data and the first parameterization data are also comprised by the first input data. Operating data, for example, operating hours of the facility or, in particular for a rolling mill, the tonnage, the quantity of produced batches, slabs, or strips or coils, are also supplied to the logic via the input data.

The first output data may comprise graphical representations, for example, representations of measurement curves as a function of time or the graphical profile of a temperature.

In particular, the first piece of equipment may be designed as a particular IT system of the facility, so that first logic monitors the first piece of equipment in the form of the particular IT system.

In one advantageous embodiment, the first output data comprise a counter or an estimation of the remaining lifetime of the first piece of equipment or the facility.

The counter may in particular count how often the first piece of equipment has been operated in a certain manner, for example, under overload. The counter may also be designed in such a way that it is able to count how many operating hours the first piece of equipment has been operated under overload. Furthermore, a weighted summary may be carried out, for example, a weighted power sum including the weighting factor of time and the unit (seconds×kilowatts). In particular for overload situations, higher and/or longer-lasting overloads may thus be taken into account using a higher weighting. Such a counter is thus an overload counter which makes it possible to draw conclusions about how often or how long the first piece of equipment and/or the facility may again be operated under overload.

Alternatively to the counter, the first output data may include an estimation of the remaining lifetime of the first piece of equipment or the facility.

The first output data thus include valuable information about the first piece of equipment or the facility, on the basis of which, for example, repair or maintenance work may be scheduled and carried out.

In an additional advantageous embodiment, the first output data comprise a first numerical value of a range, wherein the first logic expands the first output data into expanded first output data if at least a given first value is reached or exceeded, by adding an additional piece of information.

The numerical values of the range may be designed in such a way that they are interpretable as levels which characterize an OK condition or a NOT-OK condition of the first piece of equipment or the facility. For example, a low first numerical value may describe an OK condition, and a higher first numerical value may describe a NOT-OK condition. Levels from 1 to 10 are conceivable, wherein level 10 is the highest alarm level for a critical or hazardous condition of the first piece of equipment or the facility.

The piece of additional information is, for example, “information,” “warning,” or “alarm,” depending on whether the particular first value describes a comparatively non-critical or critical NOT-OK condition. Furthermore, the additional piece of information may comprise the localization of the first piece of equipment, or may comprise an “information package” which may be provided to a maintenance employee as initial information for further handling a corresponding maintenance order.

In another advantageous embodiment, first validity criteria are provided for reducing the quantity of, or excluding, erroneous first output data, wherein the first validity criteria are comprised by the first input data.

The validity criteria are furthermore taken into account via the first logic, which ensure that erroneous first output data or false alarms may be excluded or their number reduced. For example, the validity criteria ensure that the operating mode of the first piece of equipment or the facility is suitable for calculating valid first output data. Thus, the first validity criteria ensure the validity of the first output data.

In addition, the validity criteria may be supplied to a monitoring management which is possibly available.

In another advantageous embodiment, an additional piece of equipment of the technical facility is monitored by the following method:
supplying additional input data to an additional logic,
carrying out an evaluation of the additional input data via the additional logic,
outputting additional output data, which characterize an additional condition of the monitored additional piece of equipment, via the additional logic,
   wherein the additional input data comprise
additional sensor data which are provided by additional sensors situated in the facility, additional data calculated by an additional process model, wherein the additional process model maps an additional process of the facility, or
additional automation data of an additional function of an additional automation system of the facility,
additional design data which characterize physical variables of the additional piece of equipment and/or the facility,
additional parameterization data which are variable and predefinable data with respect to the additional piece of equipment and/or the facility, and
the operating data.

The monitoring of at least one additional piece of equipment makes it possible to consider more complex facilities which, for example, comprise multiple, different pieces of equipment. This is possible due to the fact that the additional logic and possibly multiple additional logics are available, which also makes it possible to draw conclusions with respect to more complex relationships. Such relationships may, for example, be already-known or previously unknown interactions between the first piece of equipment and the additional piece of equipment.

In an additional advantageous embodiment, the first output data are output to a monitoring management if a second numerical value of a range of the first output data reaches or exceeds a given second value.

Depending on the second numerical value, the first output data are relayed to the monitoring management, which, for example, is referred to as the “information broker”. The transmission of the first output data to the monitoring management may, for example, also be carried out as a function of the aforementioned validity criteria and/or the additional piece of information of the expanded first output data.

It is possible, for example, to access the monitoring management remotely, for example, via the Internet, using mobile devices and/or using queries. It may be provided that the monitoring management reads in data from mobile devices and/or outputs data to mobile devices.

The monitoring management thus provides a user interface which may make the additional piece of information available to the users as necessary. As mentioned above, the additional piece of information may, for example, be the “alarm” information or the localization of the first piece of equipment. The users may filter the displayed additional piece of information according to particular criteria, for example, according to the point in time of the creation or storage of the additional piece of information, according to the classification of the additional piece of information, according to equipment, etc. Furthermore, additional information about the alarm may be collected from the users, for example, comments and evaluations of whether the additional piece of information is evaluated as being false-positive.

With respect to the monitoring management, the first logic may additionally provide standardized operations which it is able to call, for example, querying and determining particular parameters, querying actual values, and triggering calculations. The results of the operations may be composed in a particular format, which may be formulated in a description language such as an XML schema definition (XSD) or a document type definition (DTD). This makes it possible to patent data in a simple manner. The data required for the first logic for a specific piece of equipment may be recorded in a description file which is machine-readable and is able to be processed further. Furthermore, for example, the addresses of one of the IT facilities and/or one of the automation systems of the facility from which data are called, one or multiple unambiguous identifiers (ID), the serial number(s) of the monitored first piece of equipment or the facility and possibly of a monitored additional piece of equipment, and the address of the monitoring management may possibly belong.

In an additional advantageous embodiment, the monitoring management outputs a semantic representation at least of the first input data.

The semantic representation is adapted to the particular first piece of equipment to be monitored. In particular if a more complex facility exists including multiple pieces of equipment and logics, the semantic representation may be designed in such a way that multiple first input data may be analyzed.

The semantic representation may be designed in such a way that a structuring in the form of a view or an order of the underlying data with respect to time and/or place is made possible. The time and the place may characterize the time and the place of the origin or the recording of at least the first input data. Furthermore, the view or the order may also be made possible with respect to different plants and interests, for example, ordered according to drives or aggregates such as pumps, according to lubricated or cooled components, according to the cost center, or according to the cause and effect. The structuring may be carried out in a freely selectable and changeable manner by selected users of the monitoring management.

In an additional advantageous embodiment, the monitoring management triggers at least one of the following actions:
carrying out an evaluation of the first input data by the additional logic,
carrying out an evaluation of the additional input data by the first logic,
changing one or multiple data collection parameters which characterize the provision of the first sensor data via the first sensors or the provision of the additional sensor data via the additional sensors,
routing the additional piece of information to a first IT system or to a second automation system of the facility if the expanded first output data comprise an additional piece of information,
notifying persons or groups of persons at an operating company of the facility and/or a service provider.

The evaluation of the first input data by the additional logic allows a more comprehensive view of the first piece of equipment and may be triggered by the monitoring device. For example, the first input data comprise vibration data and temperature data with respect to the first piece of equipment, wherein the vibration data may be evaluated by the first logic and the temperature data may be evaluated by the additional logic. It is thus possible to detect and take into account more complex relationships and interactions.

In addition, it is also possible to evaluate the additional input data by the first logic. For example, the first input data comprise vibration data of the first piece of equipment, and the additional input data comprise vibration data of the additional piece of equipment, so that the first logic evaluates the vibration data of each of the two pieces of equipment. This makes it possible to use simpler logics.

Furthermore, the monitoring management may cause data collection parameters, for example, the sampling rate or the resolution of the first sensor and/or the additional sensor, to be changed. In particular, if the first piece of equipment is in a critical condition, the data collection may be designed to be more detailed, so that possible damage profiles or interactions of a complex facility may be made more accessible or detectable.

The routing of the additional piece of information to the first IT system or to the second automation system of the facility may also be initiated by the monitoring management. The first IT system may subsequently carry out an additional analysis, for example, data mining, in order to ascertain and evaluate correlations, in particular with respect to the usage, the product quality, the condition of the first piece of equipment or of the facility, and/or the costs.

In particular, the additional “alarm” information may be relayed to the second automation system of the facility, so that the facility may be shut down if necessary. Thus, it is possible to prevent serious damage to the rest of the facility and to reduce costs. In particular, the additional piece of information may comprise an “information package” which may be provided to a maintenance employee as preliminary information for further handling a corresponding maintenance order.

At the instigation of the monitoring management, the facility operators or service providers, for example, persons responsible for repairs and/or maintenance, may also be informed, so that the availability of the facility is increased. This is in particular the case if the responsible persons are informed in a timely manner before the occurrence of a more serious problem, for example, if the expanded first output data include the additional piece of “warning” information. It is also conceivable to trigger a maintenance order, for example, by the additional piece of information being output to a computerized maintenance management system (CMMS).

In an additional advantageous embodiment, the provision of the first sensor data is carried out via the first sensors and/or the evaluation of the first input data is carried out via the first logic, as a function of the condition of the first piece of equipment or as a function of the first function of the first automation system.

The provision of the first sensor data or the evaluation of the first sensor data by the first logic as a function of the condition of the first piece of equipment or as a function of the first function of the first automation system makes it possible to reduce the communication complexity within the facility or the complexity of the evaluation of the first sensor data. This may be carried out without affecting the quality of the monitoring of the first piece of equipment, for example, by providing or evaluating the first sensor data only in those situations in which the first piece of equipment or the facility runs under full load, or at least heavy loads are to be expected. For example, such a situation may be the power-up of the first piece of equipment or the facility, if the lubricant temperature is very low. In particular, such a situation may also exist if it is to be expected that the refrigerant temperature is high, for example, when the electrical power consumption is highest within an operating cycle of the first piece of equipment or the facility.

It is also conceivable to carry out the provision or evaluation of the first sensor data via the first logic having a predefined cycle time, for example, every minute, hourly, daily, or the like.

In addition, the provision of the calculated first data and/or the provision of the first automation data may also be a function of the condition of the first piece of equipment or a function of the first function of the first automation system. Furthermore, the aforementioned data may also be provided as a function of the condition of the facility if the condition of the facility is accessible, which, for example, may be achieved by multiple logics monitoring the total facility. Finally, the provision of the remaining first input data may be carried out using such dependencies.

In an additional advantageous embodiment, the method is carried out periodically, wherein the period is changeable via the monitoring management.

Changing the period allows, for example, increasing the resolution of measured first sensor data, of measurement curves, or of derived curves. As a result, it is possible to achieve a particularly accurate monitoring of the first piece of equipment, which, for example, is required if the additional piece of information of the expanded first output data is “warning” or “alarm.”

If an additional logic is available, the monitoring management may possibly also change the period of method which relates to the additional logic.

In an additional advantageous embodiment, the first output data are output to a monitoring management if a second numerical value of a range of the first output data reaches or exceeds a given second value, wherein the monitoring management stores at least the first input data and the first output data as a first snapshot in a first long-term archive if a third numerical value of a range of the first output data reaches or exceeds a given third value and/or if the long-term archiving is manually triggered.

In addition to the first input data and the first output data, the first snapshot may possibly also include the additional piece of information, for example, the aforementioned “information package.”

The storage of the first snapshot is used to analyze the condition of the first piece of equipment or the facility more accurately in retrospect. This analysis may, for example, be carried out if the first piece of equipment is maintained, repaired, or exchanged, and now, for example, the wear and tear of the first piece of equipment is to be reconstructed. This thus also allows conclusions to be drawn about the future behavior of the first piece of equipment or structurally similar pieces of equipment of the facility.

The storage of the first snapshots may also be manually triggered, in particular during the acceptance of the facility by the operator after commissioning, at the conclusion of maintenance measures, in the event of disasters, or in the event of spontaneous failures.

In addition to a first snapshot, the monitoring management may also store an additional snapshot in the first long-term archive, wherein the additional snapshot comprises at least the additional input data and the additional output data. In addition, the particular additional piece of information may possibly be comprised by the particular snapshot, the particular additional piece of information then also being stored together with the particular snapshot in the long-term archive.

In an additional advantageous embodiment, the first logic stores at least the first input data and the first output data as a second snapshot in a second long-term archive if a fourth numerical value of a range of the first output data reaches or exceeds a given fourth value and/or if the long-term archiving is manually triggered.

If it is desired that the first logic continually stores the first input data and the first output data in the second long-term archive, the given fourth value may be selected to be correspondingly low.

Alternatively or in addition to the first logic, the first input data and the first output data may also be stored via the monitoring management in the second long-term archive.

Additional input data and additional output data may also possibly be stored by the monitoring device or another logic as an additional snapshot in a long-term archive.

In an additional advantageous embodiment, predefinable snapshots stored in the first long-term archive or the second long-term archive remain disregarded in the event of a data compression or data deletion.

Such predefinable snapshots may, for example, be those which were stored during the acceptance of the facility by the operating company after commissioning, or after the conclusion of maintenance measures. As a result of these snapshots not being compressed or deleted, it is possible to compare the condition of the first piece of equipment or the facility with these reference conditions in a reliable manner, even if much time has elapsed in the meantime and the data of the long-term archive have been partially compressed or deleted due to insufficient storage capacity.

In an additional advantageous embodiment, the first snapshot and a simultaneously recorded additional snapshot, which comprises at least the additional input data and the additional output data, are stored in the first long-term archive and/or in the second long-term archive, having a shared reference.

The reference is, for example, a time stamp, so that as a result of the storage together with the reference, the first snapshot or the additional snapshot allows conclusions to be drawn about the condition of the first piece of equipment or the additional piece of equipment at a desired point in time. In particular, the shared storage of the first snapshot, the additional snapshot, and the shared reference in the first long-term archive and/or in the second long-term archive make it possible to analyze and examine relationships and interactions between, for example, the first piece of equipment and the additional piece of equipment, in particular, even after much time has meanwhile elapsed since the shared storage.

The shared reference ensures, for example, that the first snapshot and the additional snapshot were taken simultaneously or have a temporal relationship. By storing multiple first snapshots or multiple additional snapshots which were each created in a particular temporal sequence, it is additionally possible to reconstruct and evaluate the temporal profile of the condition of the first piece of equipment or the additional piece of equipment, as well as interactions between the first piece of equipment and the additional piece of equipment.

In an additional advantageous embodiment, if the first validity criteria are not met at a given point in time, the latest or next valid first snapshot having the same reference is stored in the first long-term archive and/or in the second long-term archive, like each additional snapshot of the given point in time.

As a result, the evaluability and thus the significance of the stored snapshots are improved.

In an additional advantageous embodiment, at least the first input data and the first output data are stored in a buffer if a fifth numerical value of a range of the first output data reaches or exceeds a given fifth value.

The buffer is a different storage option for long-term storage which, for example, may be implemented in the form of a circular buffer. In particular, the current first input data and the current first output data are continually stored in the buffer, wherein possibly in addition, the current additional input data and the current additional output data, as well the additional piece of information possibly available in each case, may be stored.

With the buffer, it may be provided that the new stored data are written into the memory location of the oldest data stored in the buffer, so that the oldest data stored in the buffer are overwritten and are lost. Thus, the current data in each case and, depending on the storage capacity of the buffer, the particular data up to a desired point of time in the past, may be stored in the buffer. As a result, the data are available to the monitoring management or an additional analysis unit, for example.

The storage of the first input data and the first output data may, for example, be carried out via the first logic or the monitoring management. A storage of additional input data and additional output data may possibly also be carried out via an additional logic or the monitoring management.

In an additional advantageous embodiment, a report is created and the format of the report is adapted to a specific output medium if a sixth numerical value of a range of the first output data reaches or exceeds a given sixth value.

The report may in particular comprise the first input data and the first output data, wherein, for example, the additional input data and the additional output data may also be recorded in the report. The report may also possibly include the particular additional piece of information, wherein the report, for example, may be stored in the long-term archive and/or in the buffer.

Furthermore, it is conceivable that the report is transmitted to a second IT system or a third automation system of the facility, which may then carry out additional processing based on the report. Finally, the report may also be displayed by the monitoring management or made available to its users.

The format of the report is adapted to specific output media, for example, printing on paper, displaying on a screen of a PC or mobile device, or sending by email or via SMS, and the like. The report may, for example, be accessed remotely, for example, via the Internet, using mobile devices and/or using queries.

The report may, for example, be created cyclically, for example, monthly. It may also be created if the sixth numerical value of a range of the first output data reaches or exceeds a given sixth value.

Moreover, the given sixth value may be chosen so low that the report is continually created. In addition, the given sixth value may be identical to at least one of the given second to fifth values. Corresponding considerations apply in equal measure in each case to the given second, third, fourth, and fifth values.

The first and/or second automation system may be carried out identically to the third automation system. The first IT system and the additional IT system may be implemented via a single IT system.

In an additional advantageous embodiment, at least the first sensors are also used for a third automation system of the facility.

The use of the first sensors both for the purposes of the third automation system and for the purposes of monitoring the first piece of equipment and/or the facility makes it possible to cut costs and to reduce the installation complexity for monitoring the first piece of equipment and/or the facility. This is due to the fact that the third automation system generally requires sensors, wherein an advantage results due to the first sensors required for the third automation system also being used for monitoring the first piece of equipment. Thus, no additional complexity or additional costs arise for monitoring the first piece of equipment, at least with respect to the first sensors.

In an additional advantageous embodiment, the first sensors are designed as virtual sensors.

The virtual sensors, also referred to as “soft sensors,” may, for example, be designed as software which processes multiple measurements from sensors designed as hardware or other signals, and outputs a corresponding measured value. The measurements which are based on the virtual sensors may be carried out in the first piece of equipment, possibly the additional piece of equipment, one of the automation systems of the facility, one of the IT systems in the facility, and/or another part of the facility. For example, the virtual sensors may be embodied in such a way that their measured values are also outputs of digital regulating systems or frictional coefficient calculations.

Based on the virtual sensors, it is in particular possible to infer physical variables which are otherwise not accessible for measurement or detection. The virtual sensors thus provide virtual measured values which, for example, result only during calculations by the particular automation system and which, for example, may be correction factors which are ascertained for adapting the process automation to the existing facility.

For example, in a rolling mill, a temperature model is used in process automation. The temperature model may comprise a correction factor for the heat transfer between the surroundings and the rolled steel strip. As long as the facility hardly changes its condition, the correction factor will also hardly change, provided that the model used in the process automation remains the same. Thus, the correction factor describes the facility condition in a global, i.e., comprehensive manner. If the correction factor changes significantly, this generally means that the process automation model used no longer describes the facility in an optimal manner. If this model was not changed, the condition of the facility itself has thus changed. Therefore, it may be highly advantageous to monitor the correction factor instead of individual measured values from the facility.

In an additional advantageous embodiment, the parameterization data are changed using predefinable dynamics.

The dynamics may, for example, may be designed as a learning algorithm by which the first logic may be trained with respect to the detection of the first condition of the monitored first piece of equipment and/or the facility. For example, envelopes comprised in the parameterization data are adjusted by the dynamics so that the allowable first input data change with time.

This is advantageous if the first piece of equipment and/or the facility, and thus the allowable first sensor data, the calculated first data, or the first automation data, change in the long term, but minimally, for example, as a result of wear or the aging of parts of the first piece of equipment and/or the facility. This is due to the fact that as a result of wear or aging, the allowable range of the first input data shifts gradually, for example, the first sensor data, the calculated first data, or the first automation data, so that the first logic would eventually identify allowable first input data as unallowable, and/or would identify unallowable first input data as allowable. The first logic may be manually or automatically retrained at certain time intervals, so that the allowable range of the first input data is updated. The allowable range may be limited by an allowable rate of change and/or its change gradient, so that the allowable first input data are allowed to change only by a fixedly predefined value within a particular period of time. Thus, even in the case of a slowly changing first piece of equipment and/or facility, the first logic may also detect suddenly occurring “outliers” of first input data which lie outside the currently allowable range.

Here, it is interesting to optimize the predefinable dynamics and their parameters globally across multiple pieces of equipment. In the case that pieces of equipment from multiple facilities are monitored by the proposed method, the optimization may also be carried out across these facilities or their pieces of equipment and/or corresponding long-term archives. The optimized parameters of the predefinable dynamics thus obtained may subsequently be used as a starting value.

For example, estimations of parameters for a piece of equipment in a used condition which is installed in the facility may also be used as a starting value, wherein the correct limits for the present wear of this piece of equipment may thus be used from the outset.

For example, a “random forest” algorithm may be used as a learning algorithm in order to train the first logic with respect to the detection of the reliability of the first condition of the monitored first piece of equipment. For this purpose, a fixed number of decision trees is determined, wherein each of the decision trees is evaluated in order to determine the learning of the dynamics. In order to update the first logic dynamically, a particular number of existing decision trees may now be deleted in each retraining step, preferably those which describe the amount of training most poorly. They are now replaced by newly determined decision trees. The proportion of decision trees to be replaced may be set previously, wherein this proportion determines how strongly the model is allowed to respond to changes when updating.

Alternatively to the “random forest” algorithm, other learning algorithms may be used, for example, multiple neural networks, which are partially replaced during each retraining exactly like the decision trees. Furthermore, polynomial regression may be used, wherein the regression terms remain the same even during retraining, and only their coefficients may be changed within narrow limits.

In an additional advantageous embodiment, the predefinable dynamics are changeable as a function of the first input data.

The predefinable dynamics may be influenced by the first input data, for example, by the first sensor data, in particular if the first sensors are designed as virtual sensors. Thus, based on correction factors for adapting the first automation system, the dynamics may take information into account about how well the facility in the current condition fits the first logic or the model of the first automation system stored in it. In the case that these correction factors hardly change over time, it may be provided that the dynamics and thus also the first logic for monitoring the first piece of equipment change only minimally. However, if the correction factors change significantly, a more comprehensive automatic retraining of the dynamics may then also be allowed.

Viewed overall, a major ambition of the facility operators is to form information from measured values and data having content which may then be used for planning the maintenance and for decision-making. Today, the recording and storage of a plurality of data is technically no longer a problem.

One aspect is to make possible the integration of all results of mobile and online systems and manual reproductions, wherein the results may be stored in the buffer, in the long-term archive, and/or one of the IT systems or the like. Furthermore, using the advantageous embodiments above, a secured long-term knowledge base about the facility condition may be established, wherein the facility condition and the relationships of all stakeholders may be made transparent. As a result, expert knowledge may be archived independently of individual knowledge, wherein a holistic approach may be made possible in a cause-effect analysis via multiple views, for example, with respect to location, time, cause, and effect. Furthermore a comparison of facility parts and an integrated support of maintenance workflows are possible.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a schematic representation of the proposed method,

FIG. 2 shows a schematic representation of a storage of a first snapshot in a long-term archive and in a buffer,

FIG. 3 shows a representation of first input data,

FIG. 4 shows an additional representation of first input data, and

FIG. 5 shows a schematic representation of a monitored first piece of equipment and multiple monitored additional pieces of equipment.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

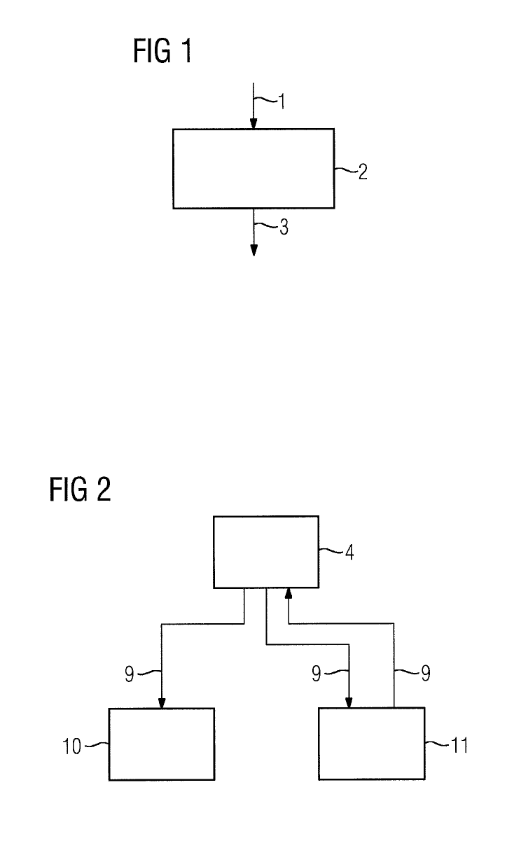

FIG. 1 shows a schematic representation of the method according to the inventors' proposals. In order to monitor a first piece of equipment of a technical facility and/or the facility for manufacturing a product, first input data 1 are transmitted to a first logic 2. The first logic 2 carries out an evaluation of the first input data 1 and outputs first output data 3 which characterize a first condition of the monitored first piece of equipment and/or the facility. According to the present proposals, the first input data 1 comprise first sensor data, calculated first data or first automation data, as well as first design data, first parameterization data, and operating data.

In the case that an additional piece of equipment of the technical facility is monitored, the method is used, in which additional input data are transmitted to an additional logic. The additional logic evaluates the additional input data and outputs additional output data.

Alternatively, it is conceivable that the additional input data are evaluated by the first logic 2, which then outputs the additional output data. Finally, the first input data 1 may alternatively also be evaluated by the additional logic, so that the additional logic outputs the first output data 3.

FIG. 2 shows a schematic representation of a storage of a first snapshot 9 in a long-term archive 10 and in a buffer 11. The first snapshot 9 comprises at least the first input data 1 and the first output data 3. The first snapshot 9 is written into the long-term archive 10 and stored there via a monitoring management 4, as indicated by the arrow pointing from the monitoring management 4 to the long-term archive 10.

In addition, the first snapshot 9 also may be written into the buffer 11 by the monitoring management 4. The buffer 11 may, for example, be designed as a circular buffer, so that the current first snapshot 9 is always stored there, wherein, for example, the current first snapshot 9 replaces the oldest first snapshot 9 stored in the buffer 11 in each case. The monitoring management 4 may read the first snapshot 9 from the buffer 11, so that the monitoring management 4 may access the content of the buffer 11.

It may possibly also be provided to store an additional snapshot, which in particular comprises additional input data and additional output data 23 of an additional piece of equipment, in the long-term archive 10 and/or in the buffer 11. Alternatively or additionally, the storage of the particular snapshot may also be carried out via the first logic 2.

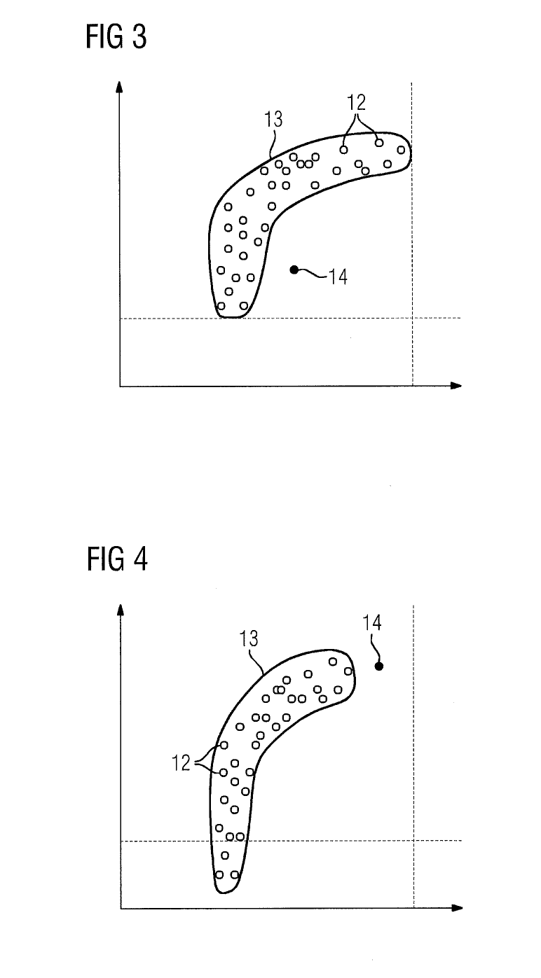

FIG. 3 shows a representation of first input data 12, 14. Each of the depicted points 12, 14 represents a complete set of first input data 12, 14, wherein each set was recorded at a different point in time. The first input data 12, 14 are depicted by an x-axis and a y-axis which may respectively represent any desired physical variables. A horizontal and a vertical dashed line are illustrated solely for purposes of orientation.

The first input data 12, 14 comprise multiple allowable data points 12 which are situated within an allowable range 13, and an unallowable data point 14 which is situated outside an allowable range 13. The allowable range 13 is, for example, stored as an envelope in the parameterization data, which again are comprised by the first input data 12, 14. Solely for the sake of improved clarity, not all first input data 12 situated in the allowable range 13 were provided with a reference numeral.

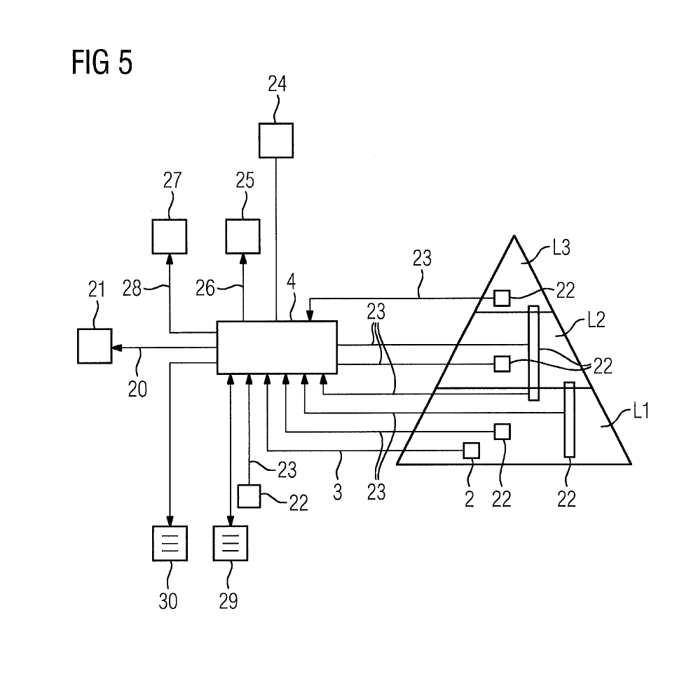

FIG. 4 shows an additional representation of first input data 12, 14, wherein the x-axis and the y-axis represent the same physical variables as in FIG. 3, and the position of the dashed lines also corresponds to those in FIG. 3. The first input data 12, 14 depicted in FIG. 4 again each represent a complete set, wherein each set was recorded at a different point in time. On the whole, the first input data 12, 14 depicted in FIG. 4 were created later than the first input data depicted in FIG. 3, so that the first piece of equipment was subjected to aging and wear in the meantime.

The provision of predefinable dynamics makes it possible to adjust the allowable range 13 over time in such a way that the aging and wear are taken into account when evaluating the first input data 12, 14. As a result, in comparison to FIG. 3, the allowable range 13 of FIG. 4 has shifted, which is made clear in particular by the dashed lines. As a result of the dynamics, an unallowable data point 14, which would have still been allowable when recording the situation depicted in FIG. 3, is therefore now situated outside the allowable range 13.

FIG. 5 shows a schematic representation of a monitored first piece of equipment and multiple monitored additional pieces of equipment. Within the scope of the exemplary embodiment, the depicted triangle of the monitored first piece of equipment and of the multiple monitored additional pieces of equipment is designed like a first automation system, which may be divided into different levels. A first level L1 (level 1) comprises a basic automation, for example, including sensors, electric motors, and/or controllers. A second level L2 may, for example, comprise the process optimization including a process model, and a third level L3 may comprise a “manufacturing execution system” (MES) or the like. Additional levels may also be provided. A system for enterprise resource planning (ERP) 24 may also be provided independently of the first automation system.

A first logic 2 is provided with respect to the monitored first piece of equipment. Alternatively, the first piece of equipment may also be implemented outside of the first automation system depicted as a triangle, in particular as a particular IT system of the facility, so that the first logic 2 monitors the first piece of equipment in the form of the particular IT system. The first piece of equipment in the form of the particular IT system would also then provide the first input data to the first logic 2, so that the particular IT system of the facility may be monitored.

Furthermore, multiple additional logics 22 are provided, which may be situated inside or outside the depicted triangle. Those additional logics 22 which are situated inside the triangle may be situated on one of the aforementioned levels, so that their particular additional input data originates from the associated level. Some of the additional logics 22 are depicted in FIG. 5 in such a way that they extend across two or more levels, which is to be understood to mean that their respective additional input data originate from the corresponding two or more levels.

The first logic 2 and the additional logics 22 may each carry out an evaluation of first input data or additional input data supplied to each of them, and may each output first output data 3 or additional output data 23. The different output data 3 or 23 are supplied to the monitoring management 4 if a second numerical value of a range of the particular output data 3 or 23 reaches or exceeds a given value.

The monitoring management 4 may, for example, initiate the evaluation of additional input data and the output of additional output data 23 via a particular one of the multiple logics 22 if the first output data 3 of the first logic 2 reach or exceed a particular value. By ascertaining desired additional output data 23 for previously determined situations, a particularly accurate image of the piece of equipment to be monitored may be obtained and stored for an additional analysis.

Within the scope of the exemplary embodiment, it is furthermore provided that the monitoring management 4 forwards an additional piece of information 20, which may be associated with the first output data 3 via the first logic 2, to a first IT system 21. Furthermore, it is provided that the monitoring management 4 transmits a report 26 to a second IT system 25. Furthermore, a third IT system 27 is provided, for example, in the form of a computerized maintenance management system (CMMS), to which the monitoring management 4 may send a maintenance order 28. Finally, the monitoring management 4 may still be connected to the ERP 24.

The monitoring management may furthermore be connected to a mobile device 29, wherein the connection, for example, is implemented wirelessly, and makes possible a bidirectional data exchange. With the aid of the mobile device 29, for example, queries may be carried out, wherein the monitoring management 4 reads in data from the mobile device 29 and outputs data to the mobile device. In addition, a display screen 30, which is connected to the monitoring management 4, is provided for directly displaying desired data of the monitoring management 4.

In summary, the proposed device and method relate to monitoring a first piece of equipment of a technical facility for manufacturing a product, including the following:
routing first input data to a first logic,
carrying out an evaluation of the first input data via the first logic,
outputting first output data, which characterize a first condition of the monitored first piece of equipment, via the first logic. In order to improve known concepts for condition monitoring, it is recommended that the first input data comprise—first sensor data which are provided by first sensors situated in the facility,
first data calculated by a first process model, wherein the first process model maps a first process of the facility, or
first automation data of a first function of a first automation system of the facility,
first design data which characterize physical variables of the first piece of equipment and/or the facility,
first parameterization data which are variable and predefinable data with respect to the first piece of equipment and/or the facility, and
operating data which characterize the manufacture of the product.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-21. (canceled)

22. A method for monitoring a first piece of equipment of a technical facility for manufacturing a product, the method comprising:
inputting first input data to a first logic;
evaluating, by the first logic, the first input data;
outputting, from the first logic, first output data that represents a first condition of the first piece of equipment based on the evaluating, wherein the first input data includes:
first sensor data that is provided by one or more first sensors situated in the technical facility,
first data calculated by a first process model, wherein the first process model maps a first process of the technical facility, or first automation data of a first function of a first automation system of the technical facility,
first design data that represents physical variables of the first piece of equipment and/or physical variables of the technical facility,
first parameterization data that is variable and predefinable data with respect to the first piece of equipment and/or the technical facility, and
operating data that characterizes the manufacture of the product.

23. The method as claimed in claim 22,
wherein the first output data includes a counter or an estimation of a remaining lifetime of the first piece of equipment or a remaining lifetime of the technical facility.

24. The method as claimed in claim 22,
wherein the first output data includes a numerical value of a expansion range, and
wherein the first logic outputs expanded first output data when the numerical value of the expansion range reaches or exceeds a given expansion value by adding an additional piece of information to the first output data.

25. The method as claimed in claim 22,
wherein first validity criteria are provided for reducing the quantity of, or excluding, erroneous first output data, and
wherein the first validity criteria are contained in the first input data.

26. The method as claimed in claim 22, wherein the technical facility includes an additional piece of equipment and the method further comprises:
inputting additional input data to an additional logic;
evaluating, by the additional logic, the additional input data;
outputting, from the additional logic, additional output data that represents an additional condition of the additional piece of equipment, wherein the additional input data includes:
additional sensor data that is provided by one or more additional sensors situated in the technical facility,
additional data calculated by an additional process model, wherein the additional process model maps an additional process of the technical facility, or additional automation data of an
additional function of an additional automation system of the technical facility, additional design data that represents physical variables of the additional piece of equipment and/or physical variables of the technical facility,
additional parameterization data that is variable and predefinable data with respect to the additional piece of equipment and/or the technical facility, and
the operating data.

27. The method as claimed in claim 22,
wherein the first output data is output to a monitoring management when a numerical value of a monitoring range of the first output data reaches or exceeds a given monitoring value.

28. The method as claimed in claim 27,
wherein the monitoring management outputs a semantic representation of the first input data.

29. The method as claimed in claim 27,
wherein the first output data includes a numerical value of a expansion range,
wherein the first logic outputs expanded first output data when the numerical value of the expansion range reaches or exceeds a given expansion value by adding an additional piece of information to the first output data,
wherein the technical facility includes an additional piece of equipment and the method further comprises:
inputting additional input data to an additional logic;
evaluating, by the additional logic, the additional input data;
outputting, from the additional logic, additional output data that represents an additional condition of the additional piece of equipment, wherein the additional input data includes:
additional sensor data that is provided by one or more additional sensors situated in the technical facility,
additional data calculated by an additional process model, wherein the additional process model maps an additional process of the technical facility, or additional automation data of an additional function of an additional automation system of the technical facility,
additional design data that represents physical variables of the additional piece of equipment and/or physical variables of the technical facility,
additional parameterization data that is variable and predefinable data with respect to the additional piece of equipment and/or the technical facility, and
the operating data, and
wherein the monitoring management triggers at least one of:
evaluating, by the additional logic, the first input data,
evaluating, by the first logic, the additional input data,
changing one or more data collection parameters that characterize the first sensor data via the one or more first sensors or the additional sensor data via the one or more additional sensors,
routing the additional piece of information to a first IT system or to a second automation system of the technical facility when the first output data includes the additional piece of information, and
notifying persons or groups of persons at an operating company of the technical facility and/or a services provider.

30. The method as claimed in claim 22, wherein the first sensor data is provided by the one or more first sensors and/or the evaluating of the first input data is carried out via the first logic as a function of the first condition of the first piece of equipment or as a function of the first function of the first automation system.

31. The method as claimed in claim 27,
wherein the first sensor data is provided by the one or more first sensors and/or the evaluating of the first input data is carried out via the first logic as a function of the first condition of the first piece of equipment or as a function of the first function of the first automation system, and
wherein the method is carried out periodically, and wherein the period is changeable via the monitoring management.

32. The method as claimed in claim 22,
wherein the first output data is output to a monitoring management when a numerical value of a monitoring range of the first output data reaches or exceeds a given monitoring value, and
wherein the monitoring management stores at least the first input data and the first output data as a first snapshot in a first long-term archive when a numerical value of a first snapshot range of the first output data reaches or exceeds a given first snapshot value and/or when long-term archiving is triggered manually.

33. The method as claimed in claim 32, wherein the first logic stores at least the first input data and the first output data as a second snapshot in a second long-term archive when a numerical value of a second snapshot range of the first output data reaches or exceeds a given second snapshot value and/or when the long-term archiving is manually triggered.

34. The method as claimed in claim 33,
wherein predefinable snapshots stored in the first long-term archive or stored in the second long-term archive remain disregarded in the event of a data compression or data deletion.

35. The method as claimed in claim 33,
wherein the technical facility includes an additional piece of equipment and the method further comprises:
inputting additional input data to an additional logic;
evaluating, by the additional logic, the additional input data;
outputting, from the additional logic, additional output data that represents an additional condition of the additional piece of equipment, wherein the additional input data includes:
additional sensor data that is provided by one or more additional sensors situated in the technical facility,
additional data calculated by an additional process model, wherein the additional process model maps an additional process of the technical facility, or additional automation data of an additional function of an additional automation system of the technical facility,
additional design data that represents physical variables of the additional piece of equipment and/or physical variables of the technical facility,
additional parameterization data that is variable and predefinable data with respect to the additional piece of equipment and/or the technical facility, and
the operating data,
wherein the first output data is output to a monitoring management when a numerical value of a monitoring range of the first output data reaches or exceeds a given monitoring value,
wherein the monitoring management stores at least the first input data and the first output data as a first snapshot in a first long-term archive when a numerical value of a first snapshot range of the first output data reaches or exceeds a given first snapshot value and/or when long-term archiving is triggered manually, and
wherein the first snapshot and a simultaneously recorded additional snapshot, which comprises at least the additional input data and the additional output data, are stored in the first long-term archive and/or second long-term archive, having a shared reference.

36. The method as claimed in claim 33,
wherein first validity criteria is provided for reducing the quantity of, or excluding, erroneous first output data,
wherein the first validity criteria is contained in the first input data,
wherein the first snapshot and a simultaneously recorded additional snapshot, which comprises at least the additional input data and the additional output data, are stored in the first long-term archive and/or second long-term archive, having a shared reference, and
wherein, when the first validity criteria is not met at a given point in time, a latest or next valid snapshot having a same reference of the first snapshot is stored in the first long-term archive and/or in the second long-term archive.

37. The method as claimed in claim 22, wherein at least the first input data and the first output data are stored in a buffer when a numerical value of a buffer range of the first output data reaches or exceeds a given buffer value.

38. The method as claimed in claim 22, wherein a report is created and the format of the report is adapted to a specific output medium when a numerical value of a output medium range of the first output data reaches or exceeds a given output medium value.

39. The method according to claim 29, wherein at least the one or more first sensors are used for a third automation system of the technical facility.

40. The method as claimed in claim 22, wherein the one or more first sensors are virtual sensors.

41. The method as claimed in claim 22, wherein the first parameterization data is changed using predefinable dynamics.

42. The method as claimed in claim 40, wherein the first parameterization data is changed using predefinable dynamics, and wherein the predefinable dynamics are changeable as a function of the first input data.
